(19) United States
(12) Patent Application Publication
(10) Pub. No.: US 2009/0298723 A1
(43) Pub. Date: Dec. 3, 2009

(54) Method for Treating Wells by Small-Size Additive-Containing Emulsions

(76) Inventors: Fernando Leal Calderon, La Brede (FR); Bazin Brigitte, Paris (FR); Romero Carolina, Rueil-Malmaison (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/279,007

(22) PCT Filed: Feb. 13, 2007
(86) PCT No.: PCT/FR07/00268

§ 371 Date: Jun. 29, 2009

(30) Foreign Application Priority Data
Feb. 13, 2006 (FR) 06/01.231

(51) Int. Cl. C09K 8/82

(52) U.S. Cl. 507/260

(57) ABSTRACT

The invention relates to a method for treating a reservoir rock, wherein the following stages are carried out:
making a concentrated water-in-oil emulsion comprising: between 50% and 80% aqueous phase in which at least one treatment additive is dissolved and between 20% and 50% oil phase containing at least one polymeric surfactant,
shearing the concentrated emulsion so as to obtain an emulsion having drops of substantially monodispersed size and essentially below 1 μm,
diluting the monodispersed emulsion with an oil phase so as to obtain an aqueous phase dispersed at a rate below 50%, and
injecting the diluted emulsion into the reservoir rock.

### FIELD OF THE INVENTION

The present invention relates to the field of well treatment in reservoirs of low to medium permeability, in particular with an invert emulsion of very small size.

Injection of an inhibitor of mineral deposition around a well allows its productivity to be improved. This treatment is applied in particular when a well is damaged, as a result of the precipitation of insoluble mineral salts under the thermodynamic bottomhole conditions. A deposition inhibitor acting through a process of adsorption on the rock, then of progressive desorption in the production water when the well is put back into production is injected. However, treatments through injection of deposition inhibitors in aqueous phase can cause damages due to the water saturation increase in the vicinity of the well.

### BACKGROUND OF THE INVENTION

Injection of deposition inhibitors in form of invert emulsions has already been described in the profession, notably by Lawless, Smith and Collins <<Lawless, T. A., Smith, R. N., and Collins, I. R.: “Investigations into the potential for invert emulsion squeeze technology.” RSC Symposium, Ambleside, Cumbria, UK, 1997>>. The oil phase of the emulsion formulation was a low aromatic kerosine. The mean droplet size of this system ranges from 1 to 2 micrometers.

Jordan et al. <<Jordan, M. M., Collins, I. R., Gyani, G., and Graham, G. M.: “Coreflood studies to examine potential application of novel scale inhibitor products to minimize intervention during field life cycle.” SPE 74666-Aberdeen, UK, Jan. 30-31, 2002.) carry out surveys on the injection of inhibitors formulated by Collins et al., and they find that, under certain conditions, this injection in porous media can cause permeability decrease.

### SUMMARY OF THE INVENTION

The object of the present invention is to overcome the drawbacks of the prior art. It relates to the injection of a deposition inhibitor in a formulation in form of an emulsion consisting of water droplets dispersed in an oil phase. The deposition inhibitor preferably is a biodegradable product dissolved in water. The oil preferably is a vegetable oil. The surfactants that go into the formulation can preferably be selected biodegradable. The particular feature of the present emulsion is the very small size obtained for the water droplets, which allows injection of this formulation into reservoirs of low to medium permeability. This emulsion formulation prevents wells from being damaged through water entrapment.

The invention is not limited to deposition inhibitors, it can also be used with other treatment additive types. The biodegradability of the emulsion formulation is a definite but not limitative advantage.

The present invention thus relates to a method for treating a reservoir rock, wherein the following stages are carried out:

making a concentrated water-in-oil emulsion comprising: between 50% and 80% aqueous phase in which at least one treatment additive is dissolved and between 20% and 50% oil phase containing at least one polymeric surfactant,

shearing said concentrated emulsion so as to obtain an emulsion having drops of substantially monodispersed size and essentially below 1 μm,

diluting said monodispersed emulsion with an oil phase so as to obtain an aqueous phase dispersed at a rate below 50%, and

injecting said diluted emulsion into the reservoir rock.

The surfactant can be selected from among: PGPR, Simaline IE-201™.

The additive can be selected from among: a mineral deposition inhibitor (CMI for example), anticorrosion additives (amines, amides, ammonium salts), organic precipitation inhibitors (asphaltenes, paraffins, organic and inorganic acids), iron sequestering agents (EDTA, NTA), sand consolidation additives, clay stabilizers.

The oil phase can be vegetable oil, rape oil for example.

Shearing can be such that the drop size of the aqueous phase is below 0.5 μm, preferably below 0.3 μm.

The composition in wt. % of the concentrated emulsion is close to: 20% Simaline IE-20™, 72% brine and 8% CMI (Carboxy-Methyl-Inuline).

The invention also relates to an invert emulsion with an aqueous phase drop size below 1 μm, preferably below 0.5 μm, obtained by means of the above method.

### BRIEF DESCRIPTION OF THE FIGURES

Other features and advantages of the present invention will be clear from reading the description hereafter, given by way of non limitative example, with reference to the accompanying figures wherein:

FIGS. 1a and 1b show microscope images of the premix emulsions with 10% by mass of emulsifier, after Couette shearing: (FIG. 1a) Simaline IE-201 and (FIG. 1b) PGPR,

FIGS. 2a and 2b show microscope images of the premix emulsions with 20% Simaline before (FIG. 2a) and after Couette shearing (FIG. 2b),

FIG. 3 shows a microscope image of the diluted emulsion based on 20% Simaline,

FIG. 4 shows the size distribution of the diluted emulsion based on 20% Simaline,

FIG. 5 shows the viscosity of the diluted emulsion based on 20% Simaline,

FIG. 6 shows the injectivity curve of the inhibitor in form of invert emulsion at 40° C.,

FIG. 7 shows the mobility reduction during injection of the diluted emulsion and the permeability reduction after injection of the diluted emulsion,

FIG. 8 shows the permeability reduction after injection of the diluted emulsion when the oil is injected at different flow rates,

FIG. 9 shows the concentration profiles of the tracer and of the diluted emulsion at the porous medium outlet.

### DETAILED DESCRIPTION

Emulsions can be defined as colloidal systems of liquid droplets dispersed in another liquid phase. They are produced by shearing the two immiscible liquid phases, which provides the energy required to reach a metastable state by fragmentation of one phase in the other.

The stability of such dispersions is generally provided by the presence of surface-active species (either surfactants or polymers) known to adsorb on the interface and to significantly delay coalescence of the droplets.

The commonest emulsions are those containing water as a continuous phase, also referred to as “direct emulsions”, and the water-in-oil emulsions referred to as “invert emulsions”.

The present invention can use a very wide range of monomeric and polymeric non-toxic emulsifiers that are used in the food industry for making emulsions. These surfactants (monoglycerides, diglycerides, sorbitan fatty acid esters better known as SPAN, phospholipides and others) generally have long fatty acid chains that give the hydrophobic group linked to the oil phase of the oil/water interface. The polar groups of these emulsifiers are more diverse, ranging from glycerol (in monoglycerides and diglycerides) and substituted phosphoglycerides (in the phospholipides) to sorbitan highly substituted with ethylene polyoxide chains.

Polymerized surfactants of polyglycerol type, such as polyglycerol esters, can also be used as biocompatible and biodegradable surfactants. Macromolecular amphiphiles adsorb at the interface and generally give better surface covering than monomeric emulsifiers. They give emulsions a very good stability. This stability is attributed to steric and osmotic effects that prevent coalescence of the droplets of the emulsion. The best known is PGPR (Polyglycerol Polyricineoleate) used for making invert water/oil emulsions in the food industry. A mixture of polyhydroxystearate-PEG with Span 80, marketed as Simaline IE-201 (manufactured by the SEPPIC Company-France), can also be advantageously used.

For example, the mineral deposition inhibiting product can be Dequest PB-11625 (manufactured by Soplutia). It is a Carboxy-Methyl-Inuline (CMI) of molecular mass in weight of 5300 g/mol corresponding to a polymerization degree of 10 and a substitution degree of 2.5. Of course, without departing from the scope of this invention, it is possible to use other products (all the hydrosoluble well treatment products) such as: anticorrosion additives (amines, amides, ammonium salts), organic precipitation inhibiting additives such as asphaltenes, paraffins, organic and inorganic acids (HCl, lactic acid, citric acid, acetic acid), iron sequestering agents (EDTA, NTA), sand consolidation additives, clay stabilizers.

According to an embodiment of the invention, the aqueous solution is made up of injection water, or production water, with a pH value ranging between 4.7 and 5.1. This pH value is obtained by dissolving 13.60 g trihydrated sodium acetate and 1.20 g acetic acid in 100 ml distilled water. On the basis of 4% by volume, the latter allows to control the pH values of the working solutions and to stabilize them at 5.

In the examples, the oil phase is rape oil. It is also possible to use dodecane and, more generally, any oil chemically compatible with brine, the surfactants of the formulation, and the well treatment additive dissolved in water.

The emulsion according to the invention is prepared by dilution of a concentrated emulsion called premix. Document FR-99/11,745, mentioned here by way of reference, describes an operating method allowing to obtain a premix type concentrated emulsion. The premix thus is a concentrated and polydispersed emulsion that is thereafter sheared in a Couette type cell so as to obtain a monodispersed emulsion by fragmentation of the drops. The premix can contain 50% to 80% aqueous phase containing the well treatment additive used pure, 20% to 50% oil phase containing the surfactant at a concentration of 10% to 20%. This technique enables to obtain concentrated invert emulsions of drop size below 1 micrometer, with very high stabilities in the concentrated state.

The Couette cell consists of two concentric cylinders. The radius of the inner cylinder is 20 mm. It is driven by a motor at a selected angular speed ω that can reach up to 71.2 rad⁻¹. The outer cylinder is stationary and the space between the two cylinders is fixed at e=100 μm. For the maximum angular speed, very high deformation rates can be reached: \dot{γ}≈rω/e=14.200 s⁻¹. The deformation rate used for shearing the crude emulsion is 1000 s⁻¹. The premix is injected by a piston that pushes the emulsion through the annular space. The residence time of the emulsion in the cell is about 10 seconds. The Couette cell allows to produce a significant amount of emulsion (up to 1 l/h) with drop size distributions below 1 micrometer and dispersed phase fractions between 70% and 90%. Of course, other industrial systems can be used to obtain larger concentrated emulsion volumes.

The premix can be diluted without losing stability up to a dispersed phase concentration of 20%, containing 2% by mass of deposition inhibitor. A diluted emulsion containing the deposition inhibitor in aqueous solution is obtained while keeping the drop size of the diluted emulsion substantially below 1 micrometer.

The table below gives the composition of the examples of premix systems according to the invention:

| | | Surfactant | Rape oil | Brine | CMI |
|---|---|---|---|---|---|
| Systems | Surfactant | (%) | (%) | (%) | (%) |
| Example 1 | PGPR | 10 | 10 | 72 | 8 |
| Example 2 | Simaline IE | 10 | 10 | 72 | 8 |
| | 201 | | | | |
| Example 3 | Simaline IE | 20 | — | 72 | 8 |
| | 201 | | | | |

### Example 1

### Preparation of a PGPR-Based Emulsion

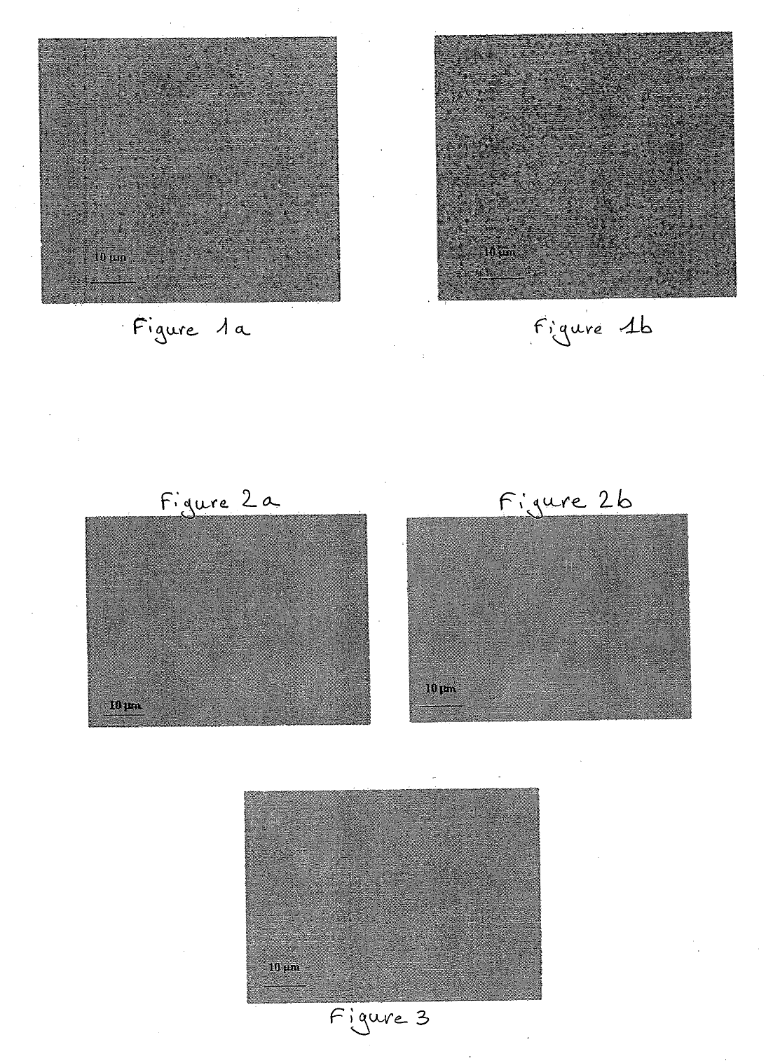

A very good premix emulsion is obtained with PGPR. Incorporation of the aqueous phase is easy and it has a homogeneous texture. The structure of this invert emulsion in concentrated form (premix) is very homogeneous, but with drop sizes above 3.0 microns. After passage through the Couette cell (FIG. 1b), the drop size is reduced and at least below 1 micrometer.

### Example 3

### Preparation of a Simaline IE-201-Based Emulsion

A very good emulsion is obtained with 20% Simaline IE-201 (Example 3). Incorporation of the aqueous phase is easy and it has a homogeneous and malleable texture. The structure of this invert emulsion is very homogeneous, but with drop sizes above 3.0 microns (FIG. 2a). After passage through the Couette cell (FIG. 2a), the drop size is reduced and at least below 1 micrometer.

After shearing of the premix in the Couette cell, it can be observed that the Simaline-based system leads to complete fragmentation of the larger droplets. The emulsion that is injected into a porous medium has been diluted to 20% dispersed phase by adding rape oil, according to system VII:

| | | Surfactant | Rape oil | Brine | CMI |
|---|---|---|---|---|---|
| System | Surfactant | (%) | (%) | (%) | (%) |
| VII | Simaline IE | 5 | 75 | 18 | 2 |
| | 201 | | | | |

A homogeneous emulsion of stable drop size, with an excellent response to the incorporation of oil (as illustrated in FIG. 3), is obtained.

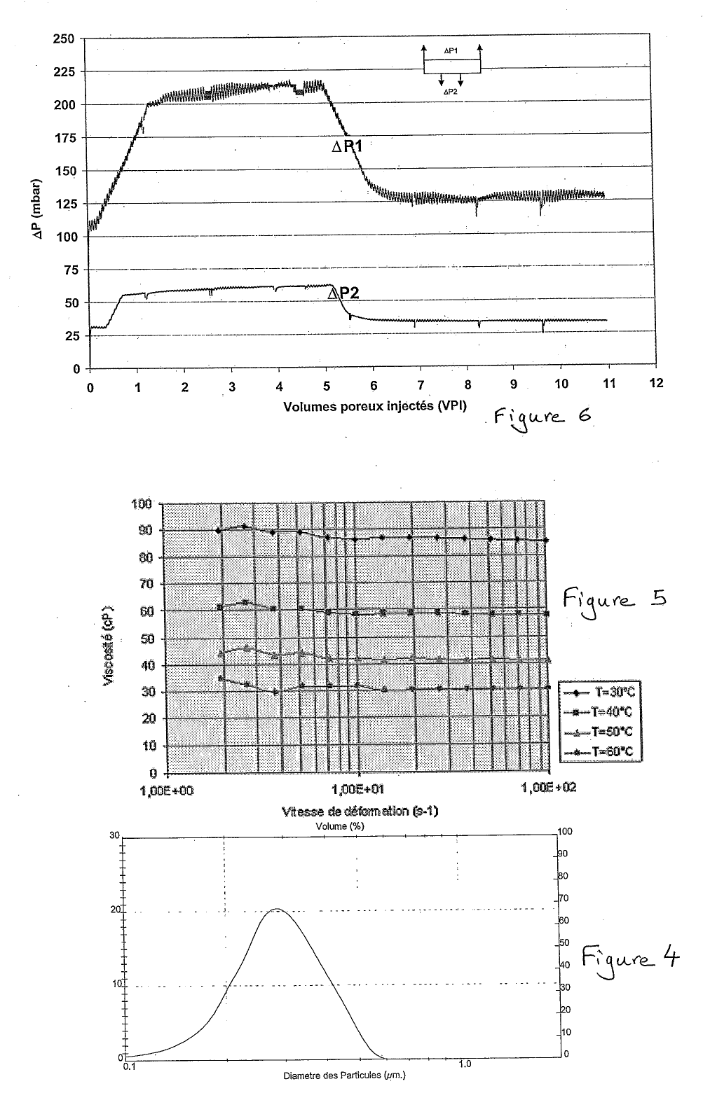

The invert emulsion with 20% aqueous phase has a mean submicronic drop size of 0.29 μm (FIG. 4). The results of the Mastersizer analysis show a monomodal and quasi-monodispersed distribution for the Simaline emulsion, with 90% droplets below 0.4 μm. Preferably, the mean size (D50) is below 0.3 μm.

The rheological curves of the invert emulsion (system VII) are given in FIG. 5. The behaviour of the emulsion is Newtonian since there is no viscosity variation with the shear rate. No stability loss or phase separation has been observed when increasing the temperature of the system (T between 30° C. and 60° C.), which is very positive for the application of the product in emulsified form. The viscosity is due to a great extent to the viscosity of the rape oil. It can be reduced using a less viscous oil in the formulation.

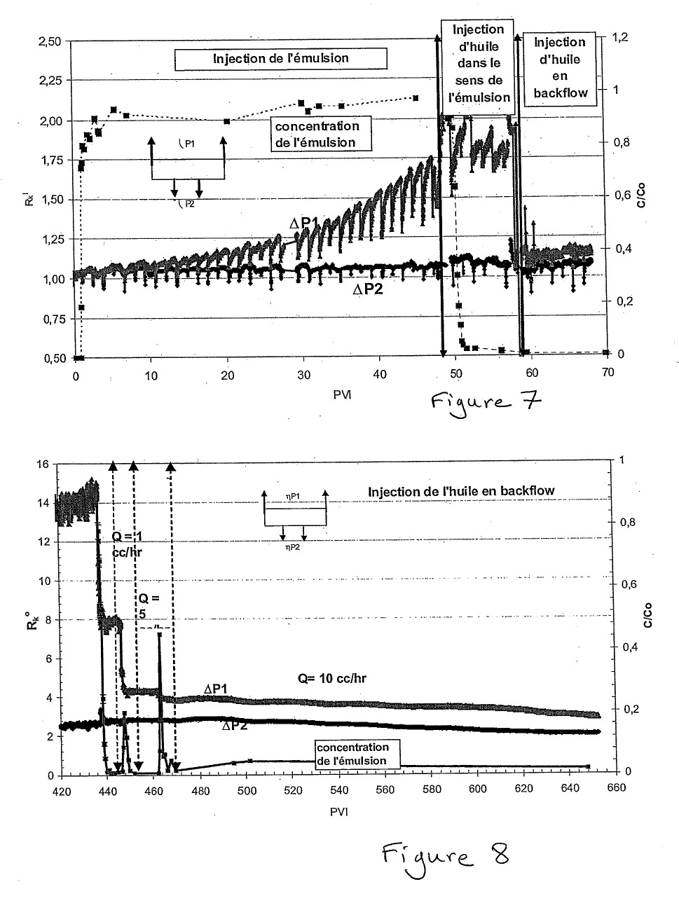

FIGS. 6 to 9 show injectivity and backflow tests carried out after applying the method according to the invention. The porous medium is described hereafter:

Characteristics of the porous medium

| | |
|---|---|
| Length, L (cm) | 9.67 |
| Diameter, d (cm) | 1.50 |
| Porosity, φ | 0.41 |
| Pore volume, VP (cm³) | 7.00 |
| Measured permeability, k (mD) | 462 |

A concentrated emulsion at a concentration of 20% aqueous phase (system VII) was injected at a flow rate of 1 cm³/hour. The results of the experiment are given in FIG. 6. This graph shows a differential pressure increase as the invert emulsion enters the porous medium. This is due to the viscosity of the emulsion, which is higher than that of the rape oil that was previously flowing. The gradual increase of ΔP during injection of the emulsion reveals a continuous retention of the emulsion. A proof of this retention is the residual ΔP, low but significant, which is observed after the reinjection of oil at the end of the experiment. ΔP1 is the total differential pressure and ΔP2 is the pressure at the porous massif inlet.

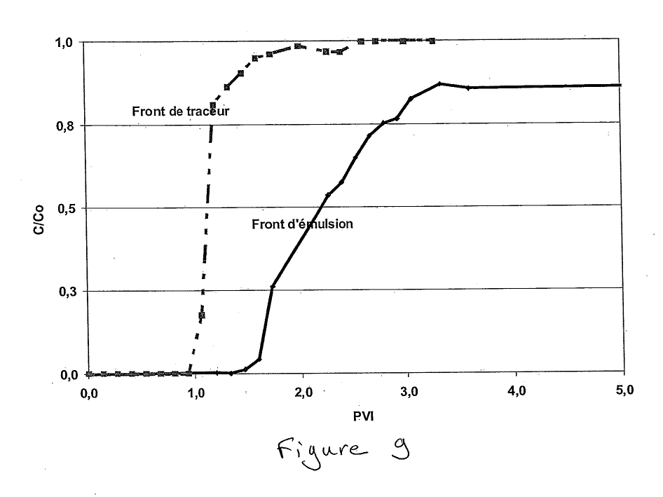

In the experiment illustrated by FIG. 7, a very large volume of emulsion, referred to as ESI, representing 50 times the volume of the porous medium, is injected. The conditions are identical to those of the experiment shown in FIG. 6. FIG. 7 shows the pressure difference variation between the inlet and the outlet of the porous medium (total ΔP) and within the porous medium (internal ΔP). The results for the pressure are translated into mobility reduction. It is the ratio of the pressure drop measured during injection of the emulsion ΔP_{ESI} to the pressure drop measured before injection of the emulsion ΔP₀ corrected of the viscosity ratio. The mobility ratio is expressed by:

$${R}_{m} = \frac{{μ}_{0}}{{μ}_{ESI}} \cdot \frac{Δ {P}_{ESI}}{Δ {P}_{0}}$$

A very good emulsion injectivity is observed, with a mobility ratio ranging between 1 and 2 at the massif inlet and a constant value of the mobility ratio within the porous medium. This result confirms that the emulsion propagation occurs without internal damage to the porous medium, for 50 pore volumes of solution injected.

When the oil is injected after the emulsion, the pressure drop is stabilized. Backflow injection of the oil, i.e. in the direction of the reservoir production, shows that the permeability of the massif is very comparable to that of the porous medium before emulsion injection since the permeability reduction is 1.1. It can be reminded that the permeability reduction is expressed by:

$${R}_{k} = \frac{Δ {P}_{oil back flow}}{Δ {P}_{0}}$$

This experiment shows that injection of the diluted emulsion VII occurs without internal damage to the porous medium.

FIG. 8 shows the results of the experiment wherein backflow injection (in the direction of production) of oil is carried out after the injection of 440 times the volume of the pores of a diluted emulsion with a concentration of 2% aqueous phase. A progressive decrease in the permeability reduction is observed when varying the flow rate, which confirms that the porous massif undergoes no damage after injection of the emulsion.

This experiment confirms the very good injectivity of this formulation that is attributed to the very small size of the emulsion droplets. It shows that, when the well is put back into production after the treatment, the well can be cleared even if the flow rate is low in the beginning. Progressive and noticeable decrease in the permeability reduction at high flow rate shows that, in the long term, the well will undergo no damage linked with emulsion injection.

FIG. 8 also shows the emulsion concentration measured in the effluents during backflow injection of the oil. A progressive desorption of the emulsion can be observed since there is still emulsion left after the injection of 640 pore volumes of oil.

It can be reminded that treatments by deposition inhibitor squeeze are efficient only if the deposition inhibitor absorbs in the porous medium and desorbs thereafter when the well is brought back into production. This inhibitor desorption allows the well to be protected against mineral deposits.

The experiment according to FIG. 9 shows the adsorption of the emulsion. The emulsion is injected with a tracer. The delay of the emulsion concentration front in relation to the tracer front is the proof of the adsorption of the emulsion. Injection of the inhibitor in emulsified phase can therefore be considered as an efficient method for squeeze treatment of producing wells.

The emulsion prepared according to the above method (according to examples 1, 2, 3 and VII) has a very good injectivity in porous media, which allows non-damaging well treatments to be carried out, and it has high efficiency considering the adsorption on the massif of the treatment additives.

1) A method for treating a reservoir rock, wherein the following stages are carried out:
making a concentrated water-in-oil emulsion comprising: between 50% and 80% aqueous phase in which at least one treatment additive is dissolved and between 20% and 50% oil phase containing at least one polymeric surfactant,
shearing said concentrated emulsion so as to obtain an emulsion having drops of substantially monodispersed size and essentially below 1 μm,
diluting said monodispersed emulsion with an oil phase so as to obtain an aqueous phase dispersed at a rate below 50%, and
injecting said diluted emulsion into the reservoir rock.

2) A method as claimed in claim 1, wherein said surfactant is selected from among: PGPR, Simaline IE-201™.

3) A method as claimed in claim 1, wherein the additive is selected from among: a mineral deposition inhibitor (CMI for example), anticorrosion additives (amines, amides, ammonium salts for example), organic precipitation inhibitors (asphaltenes, paraffins, organic and inorganic acids for example), iron sequestering agents (EDTA, NTA), sand consolidation additives, clay stabilizers.

4) A method as claimed in claim 1, wherein the oil phase is vegetable oil, rape oil for example.

5) A method as claimed in claim 1, wherein shearing is such that the drop size of the aqueous phase is below 0.5 μm, preferably below 0.3 μm.

6) A method as claimed in claim 1, wherein the composition in wt. % of said concentrated emulsion is close to: 20% Simaline IE-201™, 72% brine and 8% CMI (Carboxy-Methyl-Inuline).

7) An invert emulsion with an aqueous phase drop size below 1 μm, preferably below 0.5 μm, obtained by means of the method as claimed in claim 1.
